(19) United States
(12) Patent Application Publication
(10) Pub. No.: US 2024/0409074 A1
(43) Pub. Date: Dec. 12, 2024

(54) BRAKING SYSTEM FOR HEAVY DUTY VEHICLE

(71) Applicant: Volvo Truck Corporation, Göteborg (SE)

(72) Inventors: Pierig Gaillaud, St Genis Laval (FR); Martin Monnier, Oullins Pierre Benite (FR)

(21) Appl. No.: 18/670,174

(22) Filed: May 21, 2024

(30) Foreign Application Priority Data
Jun. 7, 2023 (EP) 23177993.5

(51) Int. Cl. B60T 13/38; B60T 8/171; B60T 8/172; B60T 13/26; B60T 13/36; B60T 13/68; B60T 17/22

(52) U.S. Cl. CPC B60T 13/385; B60T 8/171; B60T 8/172; B60T 13/268; B60T 13/36; B60T 13/683; B60T 17/22; B60T 2250/00; B60T 2270/402

(57) ABSTRACT

A braking system, comprising an air reservoir, a first brake chamber, a first flow control device connected to the first brake chamber via a second fluid conduit, a second brake chamber, a second flow control device connected to the second brake chamber via a fourth fluid conduit, a third flow control device connected between the first flow control device and the first brake chamber, a parking brake sub-system configured to apply a parking brake when an air pressure falls below a threshold, and a control unit configured to control the third flow control device to maintain the pressure inside the first brake chamber, and each of the first flow control device and the second flow control device to allow air from the air reservoir arrangement to be discharged from the braking system, until the pressure provided by the air reservoir arrangement has fallen below the predefined parking brake threshold pressure.

### PRIORITY APPLICATIONS

The present application claims priority to European Patent Application No. 23177993.5, filed on Jun. 7, 2023, and entitled “BRAKING SYSTEM FOR HEAVY DUTY VEHICLE,” which is incorporated herein by reference in its entirety.

### TECHNICAL FIELD

The disclosure relates generally to a braking system for a heavy duty vehicle. In particular aspects, the disclosure relates to a braking system configured for automatic application of a parking brake in the case of malfunction of an electronic parking brake system of the vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Various vehicles, in particular various heavy duty vehicles, use pressurized air for the operation of the braking system. In such a vehicle equipped with an electronic parking brake system there may be no satisfactory way to apply the parking brake in the event of malfunction of the electronic parking brake system.

It would be desirable to provide for improved performance of a braking system comprising an electronic parking brake system, in particular enabling improved application of the parking brake in the event of malfunction of the electronic parking brake system.

### SUMMARY

According to a first aspect of the disclosure, it is provided a braking system for a heavy duty vehicle, comprising: an air reservoir arrangement for storing pressurized air for operation of the braking system; at least one first air brake chamber configured to engage a service brake of a first wheel of the vehicle when an air pressure inside the first air brake chamber is higher than a predefined first service brake threshold pressure; at least one first flow control device connected to the air reservoir arrangement via a first fluid conduit and connected to the first air brake chamber via a second fluid conduit; at least one second air brake chamber configured to engage a service brake of a second wheel of the vehicle when an air pressure inside the second air brake chamber is higher than a predefined second service brake threshold pressure; at least one second flow control device connected to the air reservoir arrangement via a third fluid conduit and connected to the second air brake chamber via a fourth fluid conduit; at least one third flow control device connected to the first flow control device via the second fluid conduit, and to the first air brake chamber via a fifth fluid conduit; a parking brake sub-system connected to the air reservoir arrangement and configured to be controlled by an electronic parking brake system, and to automatically apply at least one parking brake to at least one wheel of the vehicle when an air pressure provided by the air reservoir arrangement falls below a predefined parking brake threshold pressure; and a braking system control unit coupled to first flow control device, the second flow control device, and the third flow control device, the braking system control unit being configured to control, in response to a set of indications including an indication of malfunction of the electronic parking brake system, an indication of a parking brake demand, and an indication that the vehicle is stationary, the third flow control device to prevent the pressure inside the first air brake chamber to go below the first service brake threshold pressure, and each of the first flow control device and the second flow control device to allow air from the air reservoir arrangement to be discharged from the braking system, until the pressure provided by the air reservoir arrangement has fallen below the predefined parking brake threshold pressure. The first aspect of the disclosure may seek to achieve safe application of the parking brake in the event of malfunction of the electronic parking brake system. A technical benefit may include to provide a braking system that does not require other driver intervention than an indication that application of the parking brake is requested. The braking system according to the disclosure may not require interaction with a human driver, but may be operated by an autonomous driving system, for example. Additionally, the braking system according to the disclosure may substantially prevent the truck from moving during the application of the parking brake.

In the present aspect, the parking brake sub-system is connected to the air reservoir arrangement and configured to be controlled by the electronic parking brake system. The parking brake subsystem is further configured to automatically apply at least one parking brake to at least one wheel of the vehicle when an air pressure provided by the air reservoir arrangement falls below a predefined parking brake threshold pressure. In the present aspect, the at least one third flow control device may be controlled to prevent the pressure inside the at least one first air brake chamber to go below the first service brake threshold pressure, while the at least one first flow control device and the at least one second flow control device are controlled to allow air from the air reservoir arrangement to be discharged. Hereby, the pressure provided by the air reservoir arrangement can be brought down to below the predefined parking brake threshold pressure, while maintaining the service brake of the at least one first wheel engaged. When the second flow control device is controlled to allow air from the air reservoir arrangement to be discharged, the air pressure inside the second air brake chamber may become lower than the second service brake threshold pressure, thereby releasing the service brake of the at least one second wheel of the vehicle. The vehicle will, however, remain stationary due to the control of the at least one third flow control device.

In some examples, including in at least one preferred example, optionally the first flow control device may be controllable between a first state in which it allows flow of air from the air reservoir arrangement into the second fluid conduit, and a second state in which it allows air from the second fluid conduit to be discharged from the braking system; the second flow control device may be controllable between a first state in which it allows flow of air from the air reservoir arrangement into the fourth fluid conduit, and a second state in which it allows air from the fourth fluid conduit to be discharged from the braking system; and the braking system control unit may be configured to control: the first flow control device to alternate between its first state and its second state; and the second flow control device to alternate between its first state and its second state, thereby allowing air from the air reservoir arrangement to be discharged from the braking system. A technical benefit may include that the first flow control device(s) and/or the second flow control device(s) need not be dedicated flow control devices arranged and configured solely for controllable reduction of the air pressure provided by the air reservoir arrangement, but that the first flow control device(s) and/or the second flow control device(s) may be the same flow control devices that would be used to control operation of the service brakes during normal operation of the vehicle.

In some examples, including in at least one preferred example, optionally the braking system control unit may be configured to control the second flow control device to alternate between its first state and its second state with an increasing alternation frequency. A technical benefit of increasing the alternation frequency from a relatively low first frequency in the beginning of the process of controllably allowing air from the air reservoir arrangement to be discharged to a relatively high second frequency, higher than the first frequency, at the end of the discharging process may include that the time to reaching the parking brake threshold pressure may be reduced, whereby the time until application of the parking brake can be reduced.

In some examples, including in at least one preferred example, optionally the air reservoir arrangement may comprise at least one first air tank connected to the first flow control device via the first fluid conduit; and at least one second air tank connected to the second flow control device via the third fluid conduit. A technical benefit may include the redundancy provided by at least two air tanks.

In some examples, including in at least one preferred example, optionally the braking system may comprise at least one fourth flow control device connected to the first air tank, to the second air tank, and to the parking brake sub-system, the fourth flow control device being configured to provide to the parking brake sub-system a highest air pressure of a first air pressure provided by the first air tank and a second air pressure provided by the second air tank.

In some examples, including in at least one preferred example, optionally the braking system may comprise at least one fifth flow control device arranged to control a flow of air between the first air tank and the second air tank, the fifth flow control device being configured to prevent flow of air between the first air tank and the second air tank in response to at least one of a first air pressure provided by the first air tank and a second air pressure provided by the second air tank becoming lower than a predefined air tank pressure.

The braking system according to various examples or combinations of examples may advantageously be included in a vehicle, further comprising vehicle wheels, where the braking system is arranged to brake at least one of the vehicle wheels.

According to a second aspect of the disclosure, it is provided a method of operating a braking system for a heavy duty vehicle, the braking system comprising an air reservoir arrangement for storing pressurized air for operation of the braking system; at least one first air brake chamber configured to engage a service brake of a first wheel of the vehicle when an air pressure inside the first air brake chamber is higher than a predefined first service brake threshold pressure; at least one first flow control device connected to the air reservoir arrangement via a first fluid conduit and connected to the first air brake chamber via a second fluid conduit; at least one second air brake chamber configured to engage a service brake of a second wheel of the vehicle when an air pressure inside the second air brake chamber is higher than a predefined second service brake threshold pressure; at least one second flow control device connected to the air reservoir arrangement via a third fluid conduit and connected to the second air brake chamber via a fourth fluid conduit; at least one third flow control device connected to the first flow control device via the second fluid conduit, and to the first air brake chamber via a fifth fluid conduit; a parking brake sub-system connected to the air reservoir arrangement and configured to be controlled by an electronic parking brake system, and to automatically apply at least one parking brake to at least one wheel of the vehicle when an air pressure provided by the air reservoir arrangement falls below a predefined parking brake threshold pressure; and a braking system control unit coupled to first flow control device, the second flow control device, and the third flow control device, the method comprising: controlling, by the braking system control unit, in response to a set of indications including an indication of malfunction of the electronic parking brake system, an indication of a parking brake demand, and an indication that the vehicle is stationary, the third flow control device to prevent the pressure inside the first air brake chamber to go below the first service brake threshold pressure, and each of the first flow control device and the second flow control device to allow air from the air reservoir arrangement to be discharged from the braking system, until the pressure provided by the air reservoir arrangement has fallen below the predefined parking brake threshold pressure. The second aspect of the disclosure may seek to achieve safe application of the parking brake in the event of malfunction of the electronic parking brake system. A technical benefit may include to provide a method of operating a braking system that does not require other driver intervention than an indication that application of the parking brake is requested. The method according to the disclosure may not require interaction with a human driver, but may be at least partly carried out by an autonomous driving system, for example. Additionally, the method according to the disclosure may substantially prevent the truck from moving during the application of the parking brake.

In the present aspect, the pressure provided by the air reservoir arrangement can be brought down to below the predefined parking brake threshold pressure, while maintaining the service brake of the at least one first wheel engaged. When the second flow control device is controlled to allow air from the air reservoir arrangement to be discharged, the air pressure inside the second air brake chamber may become lower than the second service brake threshold pressure, thereby releasing the service brake of the at least one second wheel of the vehicle. The vehicle will, however, remain stationary due to the control of the at least one third flow control device.

According to a third aspect of the disclosure, it is provided a braking system for a heavy duty vehicle, comprising: an air reservoir arrangement for storing pressurized air for operation of the braking system; a first air brake chamber configured to engage a service brake of a first wheel of the vehicle when an air pressure inside the first air brake chamber is higher than a predefined first service brake threshold pressure; a first flow control device connected to the air reservoir arrangement via a first fluid conduit and connected to the first air brake chamber via a second fluid conduit, the first pressure modulator being controllable between a first state in which it allows flow of air from the air reservoir arrangement into the second fluid conduit, and a second state in which it allows air from the second fluid conduit to be discharged from the braking system; a second air brake chamber configured to engage a service brake of a second wheel of the vehicle when an air pressure inside the second air brake chamber is higher than a predefined second service brake threshold pressure; a second flow control device connected to the air reservoir arrangement via a third fluid conduit and connected to the second air brake chamber via a fourth fluid conduit, the second pressure modulator being controllable between a first state in which it allows flow of air from the air reservoir arrangement into the fourth fluid conduit, and a second state in which it allows air from the fourth fluid conduit to be discharged from the braking system; a parking brake sub-system connected to the air reservoir arrangement and configured to be controlled by an electronic parking brake system, and to automatically apply a parking brake to at least one wheel of the vehicle when an air pressure provided by the air reservoir arrangement falls below a predefined parking brake threshold pressure; and a braking system control unit coupled to first flow control device, the second flow control device, and the third flow control device, the braking system control unit being configured to control, in response to a set of indications including an indication of malfunction of the electronic parking brake system, an indication of a parking brake demand, and an indication that the vehicle is stationary: the first flow control device to alternate between its first state and its second state, in such a way that the second flow control device is in its second state only when the first flow control device is in its first state; and the second flow control device to alternate between its first state and its second state, in such a way that the second flow control device is in its second state only when the first flow control device is in its first state, until the pressure provided by the air reservoir arrangement has fallen below the predefined parking brake threshold pressure. The third aspect of the disclosure may seek to achieve safe application of the parking brake in the event of malfunction of the electronic parking brake system. A technical benefit may include to provide a braking system that does not require other driver intervention than an indication that application of the parking brake is requested. The braking system according to the disclosure may not require interaction with a human driver, but may be operated by an autonomous driving system, for example. Additionally, the braking system according to the disclosure may substantially prevent the truck from moving during the application of the parking brake.

In the present aspect, the parking brake sub-system is connected to the air reservoir arrangement and configured to be controlled by the electronic parking brake system. The parking brake subsystem is further configured to automatically apply at least one parking brake to at least one wheel of the vehicle when an air pressure provided by the air reservoir arrangement falls below a predefined parking brake threshold pressure. In the present aspect, there is no need for the third flow control device of the braking system according to the first aspect, because the at least one first flow control device and the at least one second flow control device are controlled to alternate between their respective first and second states with such a timing that there is always at least one wheel that is braked by its service brake, in accordance with the state of the first or second flow control device configured to control flow of pressurized air to the air brake chamber of the service brake. Hereby, the pressure provided by the air reservoir arrangement can be brought down to below the predefined parking brake threshold pressure, while maintaining the service brake of at least one wheel (first wheel and second wheel alternatingly) engaged.

In some examples, including in at least one preferred example, optionally the braking system control unit may be configured to control the second flow control device to alternate between its first state and its second state with an increasing alternation frequency. A technical benefit of increasing the alternation frequency from a relatively low first frequency in the beginning of the process of controllably allowing air from the air reservoir arrangement to be discharged to a relatively high second frequency, higher than the first frequency, at the end of the discharging process may include that the time to reaching the parking brake threshold pressure may be reduced, whereby the time until application of the parking brake can be reduced.

In some examples, including in at least one preferred example, optionally the air reservoir arrangement may comprise at least one first air tank connected to the first flow control device via the first fluid conduit; and at least one second air tank connected to the second flow control device via the third fluid conduit. A technical benefit may include the redundancy provided by at least two air tanks.

In some examples, including in at least one preferred example, optionally the braking system may comprise at least one fourth flow control device connected to the first air tank, to the second air tank, and to the parking brake sub-system, the fourth flow control device being configured to provide to the parking brake sub-system a highest air pressure of a first air pressure provided by the first air tank and a second air pressure provided by the second air tank.

In some examples, including in at least one preferred example, optionally the braking system may comprise at least one fifth flow control device arranged to control a flow of air between the first air tank and the second air tank, the fifth flow control device being configured to prevent flow of air between the first air tank and the second air tank in response to at least one of a first air pressure provided by the first air tank and a second air pressure provided by the second air tank becoming lower than a predefined air tank pressure.

The braking system according to various examples or combinations of examples may advantageously be included in a vehicle, further comprising vehicle wheels, where the braking system is arranged to brake at least one of the vehicle wheels.

According to a fourth aspect of the disclosure, it is provided a method of operating a braking system for a heavy duty vehicle, the braking system comprising an air reservoir arrangement for storing pressurized air for operation of the braking system; at least one first air brake chamber configured to engage a service brake of a first wheel of the vehicle when an air pressure inside the first air brake chamber is higher than a predefined first service brake threshold pressure; at least one first flow control device connected to the air reservoir arrangement via a first fluid conduit and connected to the first air brake chamber via a second fluid conduit; at least one second air brake chamber configured to engage a service brake of a second wheel of the vehicle when an air pressure inside the second air brake chamber is higher than a predefined second service brake threshold pressure; at least one second flow control device connected to the air reservoir arrangement via a third fluid conduit and connected to the second air brake chamber via a fourth fluid conduit; at least one third flow control device connected to the first flow control device via the second fluid conduit, and to the first air brake chamber via a fifth fluid conduit; a parking brake sub-system connected to the air reservoir arrangement and configured to be controlled by an electronic parking brake system, and to automatically apply at least one parking brake to at least one wheel of the vehicle when an air pressure provided by the air reservoir arrangement falls below a predefined parking brake threshold pressure; and a braking system control unit coupled to first flow control device, the second flow control device, and the third flow control device, the method comprising: controlling, by the braking system control unit, in response to a set of indications including an indication of malfunction of the electronic parking brake system, an indication of a parking brake demand, and an indication that the vehicle is stationary, the first flow control device to alternate between its first state and its second state, in such a way that the second flow control device is in its second state only when the first flow control device is in its first state; and the second flow control device to alternate between its first state and its second state, in such a way that the second flow control device is in its second state only when the first flow control device is in its first state, until the pressure provided by the air reservoir arrangement has fallen below the predefined parking brake threshold pressure. The fourth aspect of the disclosure may seek to achieve safe application of the parking brake in the event of malfunction of the electronic parking brake system. A technical benefit may include to provide a method of operating a braking system that does not require other driver intervention than an indication that application of the parking brake is requested. The method according to the disclosure may not require interaction with a human driver, but may be at least partly carried out by an autonomous driving system, for example. Additionally, the method according to the disclosure may substantially prevent the truck from moving during the application of the parking brake.

In the present aspect, there is no need for the third flow control device of the braking system according to the first aspect, because the at least one first flow control device and the at least one second flow control device are controlled to alternate between their respective first and second states with such a timing that there is always at least one wheel that is braked by its service brake, in accordance with the state of the first or second flow control device configured to control flow of pressurized air to the air brake chamber of the service brake. Hereby, the pressure provided by the air reservoir arrangement can be brought down to below the predefined parking brake threshold pressure, while maintaining the service brake of at least one wheel (first wheel and second wheel alternatingly) engaged.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary vehicle according to an example.

FIG. 2 is an exemplary braking system according to an example.

FIG. 3 is an exemplary method according to an example.

FIG. 4 is an exemplary braking system according to an example.

FIGS. 5A-5E are exemplary diagrams illustrating example operation of a braking system.

FIG. 6 is an exemplary braking system according to an example.

FIG. 7 is an exemplary method according to an example.

FIG. 8 is an exemplary braking system according to an example.

FIGS. 9A-9B are exemplary diagrams illustrating example operation of a braking system.

FIG. 10 is an exemplary diagrams illustrating example operation of a braking system.

FIG. 11 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

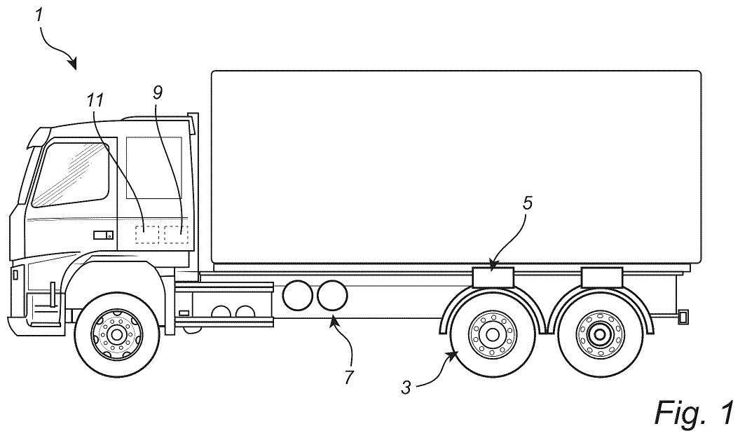

FIG. 1 is an exemplary vehicle 1 according to an example. Referring to FIG. 1, the exemplary vehicle 1 comprises vehicle wheels 3, a braking system 5, and an air reservoir arrangement 7 for storing pressurized air for operation of the braking system 5. Operation of the braking system 5 is controlled by a braking system control unit 9, and the vehicle 1 additionally comprises an electronic parking brake system 11, for electronic operation of the parking brake(s) of the vehicle 1. It should be noted that the braking system control unit 9 is functionally included in the braking system 5. Depending on the particular configuration of the vehicle 1, the braking system control unit 9 may be a stand-alone unit, or it may be implemented as a functional part of a higher level control unit.

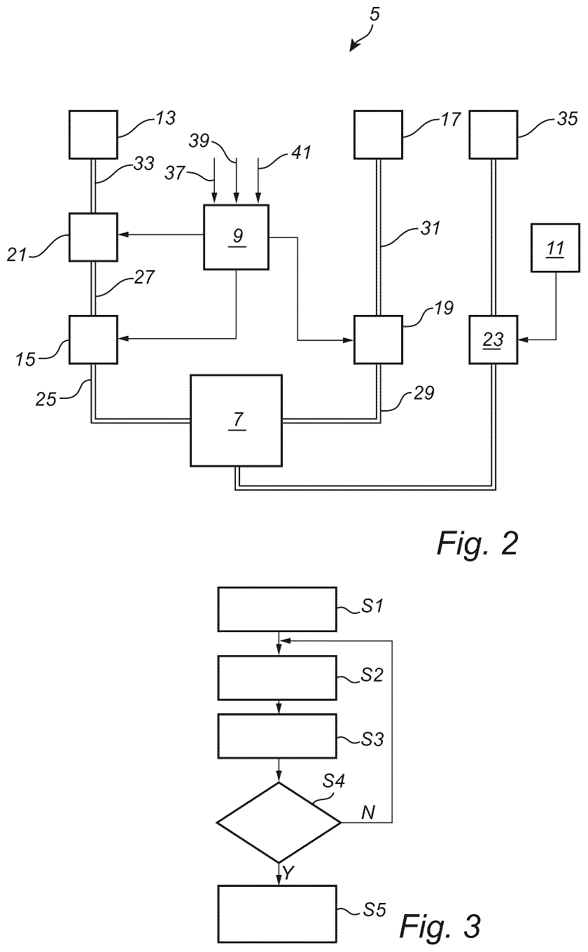

FIG. 2 is an exemplary braking system 5 according to an example. Referring to FIG. 2, the exemplary braking system 5 comprises an air reservoir arrangement 7, at least one first air brake chamber 13, at least one first flow control device 15, at least one second air brake chamber 17, at least one second flow control device 19, at least one third flow control device 21, a parking brake sub-system 23, and a braking system control unit 9. The first air brake chamber 13 is configured to engage a service brake of a first wheel of the vehicle when an air pressure inside the first air brake chamber 13 is higher than a predefined first service brake threshold pressure. Similarly, the second air brake chamber 17 is configured to engage a service brake of a second wheel of the vehicle when an air pressure inside the second air brake chamber 17 is higher than a predefined second service brake threshold pressure. As is schematically indicated in FIG. 2, the first flow control device 15 is fluid flow connected to the air reservoir arrangement 7 via a first fluid conduit 25 and connected to the first air brake chamber 13 via a second fluid conduit 27. The second flow control device 19 is connected to the air reservoir arrangement 7 via a third fluid conduit 29 and connected to the second air brake chamber via a fourth fluid conduit 31. The third flow control device 21 is connected to the first flow control device 15 via the second fluid conduit 27, and to the first air brake chamber 13 via a fifth fluid conduit 33. In the schematic illustration in FIG. 2, the braking system 5 is indicated as having one first air brake chamber 13 and one second air brake chamber 17. It should be noted that the braking system may comprise at least one additional first air brake chamber arranged and configured to brake an additional wheel different from the first wheel, and at least one additional second air brake chamber arranged and configured to brake an additional wheel different from the second wheel. With continued reference to FIG. 2, parking brake sub-system 23 is connected to the air reservoir arrangement 7 and is configured to be controlled by an electronic parking brake system. The parking brake sub-system is configured to automatically apply at least one parking brake 35 to at least one wheel 3 of the vehicle 1 when an air pressure provided by the air reservoir arrangement 7 falls below a predefined parking brake threshold pressure. The braking system control unit 9, as is schematically indicated by the single line arrows in FIG. 2, coupled to the first flow control device 15, the second flow control device 19, and the third flow control device 21. Further, the braking system control unit 9 is configured to control, in response to a set of indications including an indication 37 of malfunction of the electronic parking brake system 11, an indication 39 of a parking brake demand, and an indication 41 that the vehicle 1 is stationary, the third flow control device 21 to prevent the pressure inside the first air brake chamber 13 to go below the first service brake threshold pressure, and each of the first flow control device 15 and the second flow control device 19 to allow air from the air reservoir arrangement 7 to be discharged from the braking system 5, until the pressure provided by the air reservoir arrangement 7 has fallen below the predefined parking brake threshold pressure. Due to the provision and control of the third flow control device 21, the vehicle 1 can be substantially prevented from moving while the first flow control device 15 and the second flow control device 19 are controlled to allow air to escape from the air reservoir arrangement 7 at a sufficient rate for the pressure provided by the air reservoir arrangement 7 to fall below the parking brake threshold pressure, to thereby cause the parking brake sub-system to automatically apply the at least one parking brake, thereby securing the vehicle 1.

FIG. 3 is an exemplary method of operating a braking system for a heavy duty vehicle 1. The method comprises receiving S1 a set of indications including an indication 37 of malfunction of the electronic parking brake system 11, an indication 39 of a parking brake demand, and an indication 41 that the vehicle 1 is stationary. In response to the indications, the method proceeds to controlling S2 the third flow control device 21 to prevent the pressure inside the first air brake chamber 13 to go below the first service brake threshold pressure, and controlling S3 each of the first flow control device 15 and the second flow control device 19 to allow air from the air reservoir arrangement 7 to be discharged from the braking system 5. If the pressure provided by the air reservoir arrangement 7 has not yet fallen below the predefined parking brake threshold pressure (S4, “N”), the braking system control unit 9 continues to control the first flow control device 15, the second flow control device 19, and the third control device 21 as described above. When the pressure has fallen below the predefined parking brake threshold pressure (S4, “Y”), the parking brake sub-system 23 automatically applies S5 the parking brake 35.

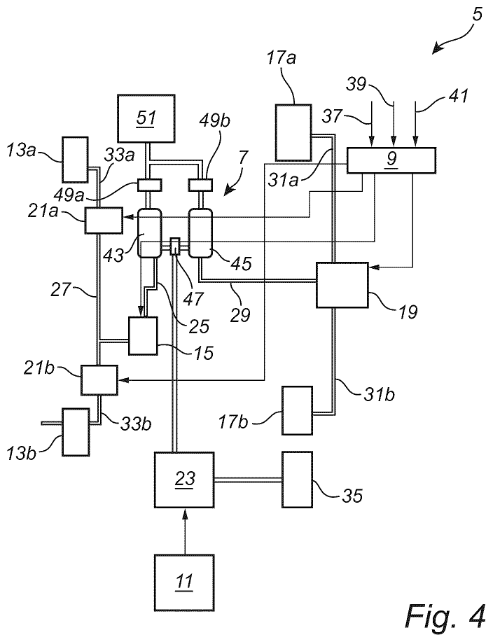

FIG. 4 is an exemplary braking system 5 according to an example. In this exemplary braking system 5, various parts are included which are not absolutely necessary for operating the braking system 5 for safe application of the parking brake of a vehicle 1 in the event of malfunction of the electronic parking brake system 11, but which may provide various advantages. It should be noted that it is also not necessary to implement all of these various parts together, but that selected ones of the parts may be chosen to be implemented depending on the requirements of a particular application.

Referring to FIG. 4, the exemplary braking system 5 comprises a pair of first air brake chambers 13a-b controllable to engage the service brakes of a pair of front wheels, and a pair of second air brake chambers 17a-b controllable to engage the service brakes of a first pair of rear wheels. During normal operation of the service brakes, the air pressures in the first air brake chambers 13a-b may be controlled by the first flow control device 15, which may, for example be an electronically controllable pressure relay, which can be controlled, by the braking system control unit 9 to deliver desired air pressures to the respective first air brake chambers 13a-b. The air pressures may be selected to achieve a desired braking torque for retarding the vehicle and/or for stabilizing the vehicle 1. Similarly, the air pressures in the second air brake chambers 17a-b may be controlled by the second flow control device 19 Between the first flow control device 15 and each of the first air brake chambers 13a-b is provided a corresponding third flow control device 21a-b. The third flow control devices 21a-b may advantageously be arranged relatively close to their respective air brake chambers 13a-b, such as substantially closer to their respective air brake chambers 13a-b than to the first flow control device 15. During normal operation of the service brakes, the third flow control device 21a-b may be controlled to provide fast variations of the air pressures in the respective air braking chambers 13a-b, for instance for preventing, or at least reducing the tendency of, the service brakes locking up. Exemplary third flow control devices 21a-b may be referred to as “pressure control valves” or PCVs. As is shown in FIG. 4, the second flow control device 19 is connected to the second air brake chambers 17a-b by respective fourth fluid conduits 31a-b, and the third flow control devices 21a-b are connected to the first air brake chambers 13a-b by respective fifth fluid conduits 33a-b.

As is schematically indicated in FIG. 4, the air reservoir arrangement 7 may comprise at least one first air tank 43 and at least one second air tank 45. The first air tank 43 may be connected to the first flow control device 15 via the first fluid conduit 25 described above with reference to FIG. 2. The second air tank 45 may be connected to the second flow control device 19 via the third fluid conduit 29 described above with reference to FIG. 2. The braking system 5 may further comprise at least one fourth flow control device 47 connected to the first air tank 43, to the second air tank 45, and to the parking brake sub-system 23. The fourth flow control device 47 may be configured to provide to the parking brake sub-system 23 a highest air pressure of a first air pressure provided by the first air tank 43 and a second air pressure provided by the second air tank 45.

With continued reference to FIG. 4, the braking system 5 may comprise at least one fifth flow control device. The fifth flow control device (each of the fifth flow control devices 49a-b) may be configured to prevent flow of air between the first air tank 43 and the second air tank 45 in response to at least one of a first air pressure provided by the first air tank 43 and a second air pressure provided by the second air tank 45 becoming lower than a predefined air tank pressure. The fifth flow control devices 49a-b may thus be configured to isolate an air production arrangement 51 from a potentially leaking tank, and such flow control devices may, for example, be referred to as overflow valves.

In a braking system 5 with the configuration in FIG. 4 (first air tank 43, second air tank 45, fourth flow control device 47, and fifth flow control device(s) 49a-b), the pressure provided by the air reservoir arrangement 7 typically cannot be brought down to the parking brake threshold pressure only by (sufficiently) emptying one of the air tanks, but both air tanks may need to be (sufficiently) emptied.

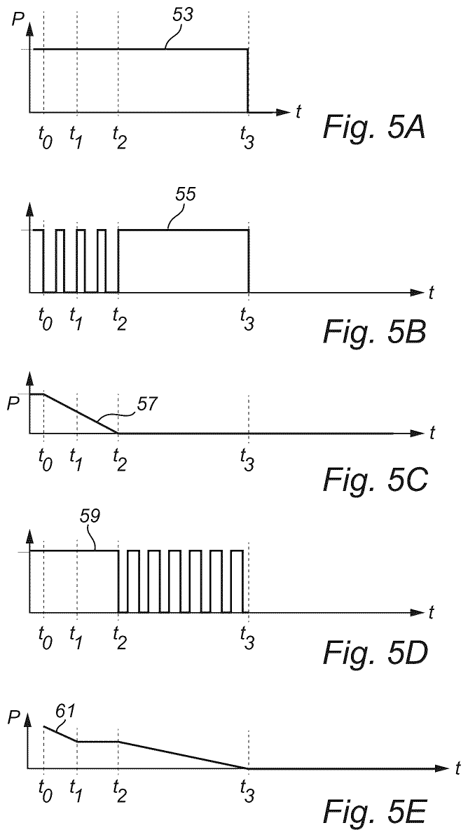

An exemplary scheme for emptying the first air tank 43 and the second air tank 45 in FIG. 4 is illustrated in FIGS. 5A-5E, which are exemplary diagrams illustrating example operation of a braking system. FIG. 5A schematically illustrates an exemplary air pressure 53 in the fifth fluid conduits 33a-b as a function of time, FIG. 5B is a graph 55 schematically illustrating an exemplary scheme for alternating between states of the first flow control device 15 as a function of time, FIG. 5C schematically illustrates an exemplary air pressure 57 in the first air tank 43 as a function of time, FIG. 5D is a graph 59 schematically illustrating an exemplary scheme for alternating between states of the second flow control device 19 as a function of time, and FIG. 5E schematically illustrates an exemplary air pressure 61 in the second air tank 45 as a function of time.

At the time t0 in FIGS. 5A-5E, the braking system control unit 9 receives the above-described set of indications including an indication 37 of malfunction of the electronic parking brake system, an indication 39 of a parking brake demand, and an indication 41 that the vehicle 1 is stationary. In response to these indications, the braking system control unit 9 controls, in this particular example, the third flow control devices 21a-b to maintain the pressure in the first air brake chambers 13a-b, thereby ensuring that the service brakes of the front wheels remain engaged. The third flow control devices 21a-b thus isolate the fifth fluid conduits 33a-b from the second fluid conduit 27, making the air pressures in the fifth fluid conduits 33a-b, and thus the air pressures in the first air brake chambers 13a-b, independent of the air pressure in the second fluid conduit 27.

The braking system control unit 9 then, in this particular example, controls the first flow control device 15 to alternate between a first state (“high” in FIG. 5B) in which it allows flow of air from the first air tank 43 into the second fluid conduit 27, and a second state (“low” in FIG. 5B) in which it allows air from the second fluid conduit 27 to be discharged from the braking system 5. As is schematically illustrated in FIG. 5C, this alternation of the first flow control device 15 between its first and second states results in a reduced air pressure in the first air tank 43, to a pressure that is lower than the parking brake threshold pressure. However, the reduction of the air pressure in the first air tank 43 will lead to the first overflow valve 49a closing at time t1, whereby the first air tank 43 and the second air tank 45 become isolated from each other, so that the second air tank 45 can no longer be emptied through the first flow control device 15. This is schematically illustrated in FIG. 5E, by a plateau in the pressure. Operation of the first overflow valve 49a will prevent the pressure provided by the air reservoir arrangement 7 to the parking brake sub-system from reaching the parking brake threshold pressure, because of the fourth flow control device 47 being configured to provide to the parking brake sub-system 23 a highest air pressure of a first air pressure provided by the first air tank 43 and a second air pressure provided by the second air tank 45.

To further reduce the air pressure 61 in the second air tank 45, the braking system control unit 9 controls the second flow control device 19 to alternate between a first state (“high” in FIG. 5D) in which it allows flow of air from the second air tank 43 into the fourth fluid conduits 31a-b, and a second state (“low” in FIG. 5D) in which it allows air from the third fluid conduits 31a-b to be discharged from the braking system 5. As is schematically illustrated in FIG. 5E, this alternation of the second flow control device 19 between its first and second states results in a reduced air pressure in the second air tank 45, until the time t3 when both the first air pressure 57 the first air tank 43 and the second air pressure 61 in the second air tank 45 have fallen below the parking brake threshold pressure, and the parking brake 35 is automatically applied. As will be apparent to one of ordinary skill in the relevant art, the order of control of the first flow control device 15 and the second flow control device 19 is not important, but the first 15 and second 19 flow control devices may be controlled to alternate between their respective first and second states at the same time or in a different order.

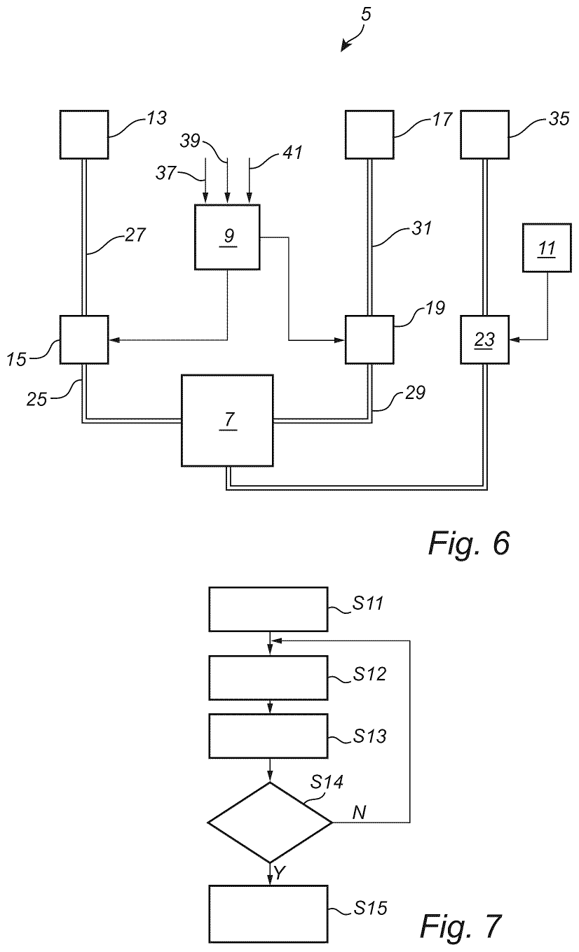

FIG. 6 is an exemplary braking system 5 according to an example. Referring to FIG. 6, the exemplary braking system 5 comprises an air reservoir arrangement 7, at least one first air brake chamber 13, at least one first flow control device 15, at least one second air brake chamber 17, at least one second flow control device 19, a parking brake sub-system 23, and a braking system control unit 9. The first air brake chamber 13 is configured to engage a service brake of a first wheel of the vehicle when an air pressure inside the first air brake chamber 13 is higher than a predefined first service brake threshold pressure. Similarly, the second air brake chamber 17 is configured to engage a service brake of a second wheel of the vehicle when an air pressure inside the second air brake chamber 17 is higher than a predefined second service brake threshold pressure. As is schematically indicated in FIG. 6, the first flow control device 15 is fluid flow connected to the air reservoir arrangement 7 via a first fluid conduit 25 and connected to the first air brake chamber 13 via a second fluid conduit 27. The second flow control device 19 is connected to the air reservoir arrangement 7 via a third fluid conduit 29 and connected to the second air brake chamber via a fourth fluid conduit 31. The first flow control device 15 is controllable between a first state in which it allows flow of air from the air reservoir arrangement 7 into the second fluid conduit 27, and a second state in which it allows air from the second fluid conduit 27 to be discharged from the braking system 5. The second flow control device 19 is controllable between a first state in which it allows flow of air from the air reservoir arrangement 7 into the fourth fluid conduit 31, and a second state in which it allows air from the fourth fluid conduit 31 to be discharged from the braking system. In the schematic illustration in FIG. 6, the braking system 5 is indicated as having one first air brake chamber 13 and one second air brake chamber 17. It should be noted that the braking system may comprise at least one additional first air brake chamber arranged and configured to brake an additional wheel different from the first wheel, and at least one additional second air brake chamber arranged and configured to brake an additional wheel different from the second wheel. With continued reference to FIG. 6, parking brake sub-system 23 is connected to the air reservoir arrangement 7 and is configured to be controlled by an electronic parking brake system. The parking brake sub-system is configured to automatically apply at least one parking brake 35 to at least one wheel 3 of the vehicle 1 when an air pressure provided by the air reservoir arrangement 7 falls below a predefined parking brake threshold pressure. The braking system control unit 9, as is schematically indicated by the single line arrows in FIG. 6, coupled to the first flow control device 15 and the second flow control device 19. Further, the braking system control unit 9 is configured to control, in response to a set of indications including an indication 37 of malfunction of the electronic parking brake system 11, an indication 39 of a parking brake demand, and an indication 41 that the vehicle 1 is stationary, control the first flow control device 15 to alternate between its first state and its second state, in such a way that the first flow control device 15 is in its second state only when the second flow control device 19 is in its first state; and control the second flow control device 19 to alternate between its first state and its second state, in such a way that the second flow control device 19 is in its second state only when the first flow control device 15 is in its first state, until the pressure provided by the air reservoir arrangement 7 has fallen below the predefined parking brake threshold pressure, to thereby cause the parking brake sub-system to automatically apply the at least one parking brake, thereby securing the vehicle 1.

FIG. 7 is an exemplary method of operating a braking system for a heavy duty vehicle 1. The method comprises receiving S11 a set of indications including an indication 37 of malfunction of the electronic parking brake system 11, an indication 39 of a parking brake demand, and an indication 41 that the vehicle 1 is stationary. In response to the indications, the method proceeds to controlling S12 the first flow control device 15 to alternate between its first state and its second state, and controlling S13 the second flow control device 19 to alternate between its first state and its second state, in such a way that the second flow control device 19 is in its second state only when the first flow control device 15 is in its first state to allow air from the air reservoir arrangement 7 to be discharged from the braking system 5. If the pressure provided by the air reservoir arrangement 7 has not yet fallen below the predefined parking brake threshold pressure (S14, “N”), the braking system control unit 9 continues to control the first flow control device 15 and the second flow control device 19 as described above. When the pressure has fallen below the predefined parking brake threshold pressure (S14, “Y”), the parking brake sub-system 23 automatically applies S15 the parking brake 35.

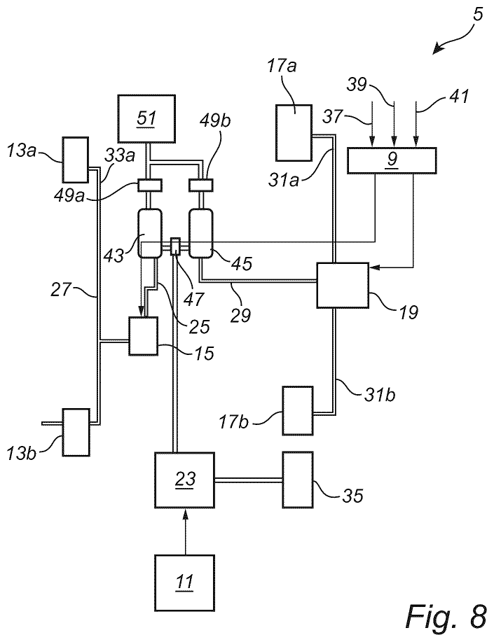

FIG. 8 is an exemplary braking system 5 according to an example. In this exemplary braking system 5, various parts are included which are not absolutely necessary for operating the braking system 5 for safe application of the parking brake of a vehicle 1 in the event of malfunction of the electronic parking brake system 11, but which may provide various advantages. It should be noted that it is also not necessary to implement all of these various parts together, but that selected ones of the parts may be chosen to be implemented depending on the requirements of a particular application.

Referring to FIG. 8, the exemplary braking system 5 comprises a pair of first air brake chambers 13a-b controllable to engage the service brakes of a pair of front wheels, and a pair of second air brake chambers 17a-b controllable to engage the service brakes of a first pair of rear wheels. During normal operation of the service brakes, the air pressures in the first air brake chambers 13a-b may be controlled by the first flow control device 15, which may, for example be an electronically controllable pressure relay, which can be controlled, by the braking system control unit 9 to deliver desired air pressures to the respective first air brake chambers 13a-b. The air pressures may be selected to achieve a desired braking torque for retarding the vehicle and/or for stabilizing the vehicle 1. Similarly, the air pressures in the second air brake chambers 17a-b may be controlled by the second flow control device 19. As is shown in FIG. 8, the second flow control device 19 is connected to the second air brake chambers 17a-b by respective fourth fluid conduits 31a-b.

As is schematically indicated in FIG. 8, the air reservoir arrangement 7 may comprise at least one first air tank 43 and at least one second air tank 45. The first air tank 43 may be connected to the first flow control device 15 via the first fluid conduit 25 described above with reference to FIG. 2. The second air tank 45 may be connected to the second flow control device 19 via the third fluid conduit 29 described above with reference to FIG. 2. The braking system 5 may further comprise at least one fourth flow control device 47 connected to the first air tank 43, to the second air tank 45, and to the parking brake sub-system 23. The fourth flow control device 47 may be configured to provide to the parking brake sub-system 23 a highest air pressure of a first air pressure provided by the first air tank 43 and a second air pressure provided by the second air tank 45.

With continued reference to FIG. 8, the braking system 5 may comprise at least one fifth flow control device. The fifth flow control device (each of the fifth flow control devices 49a-b) may be configured to prevent flow of air between the first air tank 43 and the second air tank 45 in response to at least one of a first air pressure provided by the first air tank 43 and a second air pressure provided by the second air tank 45 becoming lower than a predefined air tank pressure. The fifth flow control devices 49a-b may thus be configured to isolate an air production arrangement 51 from a potentially leaking tank, and such flow control devices may, for example, be referred to as overflow valves.

In a braking system 5 with the configuration in FIG. 8 (first air tank 43, second air tank 45, fourth flow control device 47, and fifth flow control device(s) 49a-b), the pressure provided by the air reservoir arrangement 7 typically cannot be brought down to the parking brake threshold pressure only by (sufficiently) emptying one of the air tanks, but both air tanks may need to be (sufficiently) emptied.

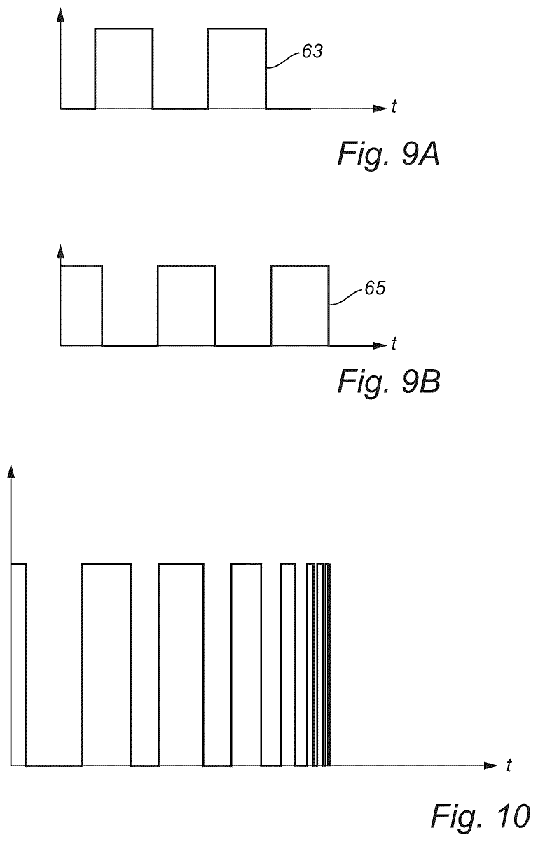

An exemplary scheme for emptying the first air tank 43 and the second air tank 45 in FIG. 8 is illustrated in FIGS. 9A-9B, which are exemplary diagrams illustrating example operation of a braking system. FIG. 9A is a graph 63 schematically illustrating an exemplary scheme for alternating between states of the first flow control device 15 as a function of time, and FIG. 9B is a graph 65 schematically illustrating an exemplary scheme for alternating between states of the second flow control device 19 as a function of time.

The braking system control unit 9 controls the first flow control device 15 to alternate between a first state (“high” in FIG. 9A) in which it allows flow of air from the first air tank 43 into the second fluid conduit 27, and a second state (“low” in FIG. 9A) in which it allows air from the second fluid conduit 27 to be discharged from the braking system 5. This alternation of the first flow control device 15 between its first and second states results in a reduced air pressure in the first air tank 43. The braking system control unit 9 also controls the second flow control device 19 to alternate between a first state (“high” in FIG. 9B) in which it allows flow of air from the second air tank 43 into the fourth fluid conduits 31a-b, and a second state (“low” in FIG. 9B) in which it allows air from the third fluid conduits 31a-b to be discharged from the braking system 5. This alternation of the second flow control device 19 between its first and second states results in a reduced air pressure in the second air tank 45. Due to the alternations substantially in anti-phase, both the first air pressure in the first air tank 43 and the second air pressure in the second air tank 45 can be reduced below the parking brake threshold pressure, and the parking brake 35 is automatically applied.

FIG. 10 is an exemplary diagram illustrating example operation of a braking system, schematically showing control of the first flow control device 15 and/or the second flow control device 19 to alternate between its first and second states with an alternation frequency that increases over time, in order to reduce the time needed to reduce the pressures in the air tanks to the desired level.

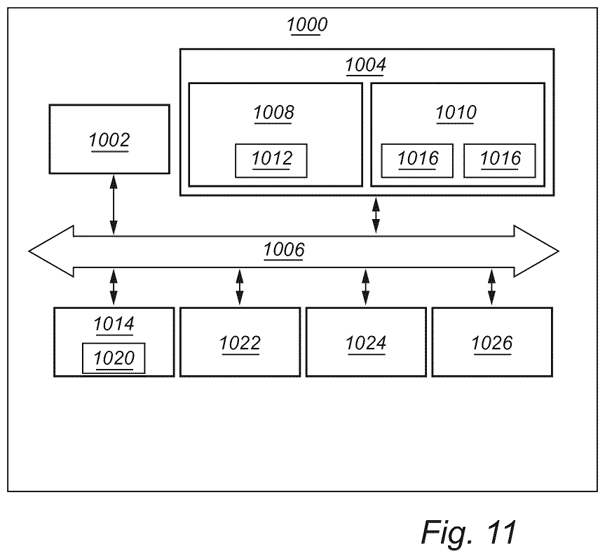

FIG. 11 is a schematic diagram of a computer system 1000 for implementing examples disclosed herein, such as for implementing examples of the braking system control unit 9 of the braking system 5 according to examples. The computer system 1000 is adapted to execute instructions from a computer-readable medium to perform these and/or any of the functions or processing described herein. The computer system 1000 may be connected (e.g., networked) to other machines in a LAN, an intranet, an extranet, or the Internet. While only a single device is illustrated, the computer system 1000 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 1000 may comprise at least one computing device or electronic device capable of including firmware, hardware, and/or executing software instructions to implement the functionality described herein. The computer system 1000 may include processing circuitry 1002 (e.g., processing circuitry including one or more processor devices or control units), a memory 1004, and a system bus 1006. The computer system 1000 may include at least one computing device having the processing circuitry 1002. The system bus 1006 provides an interface for system components including, but not limited to, the memory 1004 and the processing circuitry 1002. The processing circuitry 1002 may include any number of hardware components for conducting data or indication processing or for executing computer code stored in memory 1004. The processing circuitry 1002 may, for example, include a general-purpose processor, an application specific processor, a Digital indication Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 1002 may further include computer executable code that controls operation of the programmable device.

The system bus 1006 may be any of several types of bus structures that may further interconnect to a memory bus (with or without a memory controller), a peripheral bus, and/or a local bus using any of a variety of bus architectures. The memory 1004 may be one or more devices for storing data and/or computer code for completing or facilitating methods described herein. The memory 1004 may include database components, object code components, script components, or other types of information structure for supporting the various activities herein. Any distributed or local memory device may be utilized with the systems and methods of this description. The memory 1004 may be communicably connected to the processing circuitry 1002 (e.g., via a circuit or any other wired, wireless, or network connection) and may include computer code for executing one or more processes described herein. The memory 1004 may include non-volatile memory 1008 (e.g., read-only memory (ROM), erasable programmable read-only memory (EPROM), electrically erasable programmable read-only memory (EEPROM), etc.), and volatile memory 1010 (e.g., random-access memory (RAM)), or any other medium which can be used to carry or store desired program code in the form of machine-executable instructions or data structures and which can be accessed by a computer or other machine with processing circuitry 1002. A basic input/output system (BIOS) 1012 may be stored in the non-volatile memory 1008 and can include the basic routines that help to transfer information between elements within the computer system 1000.

The computer system 1000 may further include or be coupled to a non-transitory computer-readable storage medium such as the storage device 1014, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 1014 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 1014 and/or in the volatile memory 1010, which may include an operating system 1016 and/or one or more program modules 1018. All or a portion of the examples disclosed herein may be implemented as a computer program 1020 stored on a transitory or non-transitory computer-usable or computer-readable storage medium (e.g., single medium or multiple media), such as the storage device 1014, which includes complex programming instructions (e.g., complex computer-readable program code) to cause the processing circuitry 1002 to carry out actions described herein. Thus, the computer-readable program code of the computer program 1020 can comprise software instructions for implementing the functionality of the examples described herein when executed by the processing circuitry 1002. In some examples, the storage device 1014 may be a computer program product (e.g., readable storage medium) storing the computer program 1020 thereon, where at least a portion of a computer program 1020 may be loadable (e.g., into a processor) for implementing the functionality of the examples described herein when executed by the processing circuitry 1002. The processing circuitry 1002 may serve as a controller or control system for the computer system 1000 that is to implement the functionality described herein.

The computer system 1000 may include an input device interface 1022 configured to receive input and selections to be communicated to the computer system 1000 when executing instructions, such as from a keyboard, mouse, touch-sensitive surface, etc. Such input devices may be connected to the processing circuitry 1002 through the input device interface 1022 coupled to the system bus 1006 but can be connected through other interfaces, such as a parallel port, an Institute of Electrical and Electronic Engineers (IEEE) 1394 serial port, a Universal Serial Bus (USB) port, an IR interface, and the like. The computer system 1000 may include an output device interface 1024 configured to forward output, such as to a display, a video display unit (e.g., a liquid crystal display (LCD) or a cathode ray tube (CRT)). The computer system 1000 may include a communications interface 1026 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A braking system for a heavy duty vehicle, comprising:
an air reservoir arrangement for storing pressurized air for operation of the braking system;
at least one first air brake chamber configured to engage a service brake of a first wheel of the vehicle when an air pressure inside the first air brake chamber is higher than a predefined first service brake threshold pressure;
at least one first flow control device connected to the air reservoir arrangement via a first fluid conduit and connected to the first air brake chamber via a second fluid conduit;
at least one second air brake chamber configured to engage a service brake of a second wheel of the vehicle when an air pressure inside the second air brake chamber is higher than a predefined second service brake threshold pressure;
at least one second flow control device connected to the air reservoir arrangement via a third fluid conduit and connected to the second air brake chamber via a fourth fluid conduit;
at least one third flow control device connected to the first flow control device via the second fluid conduit, and to the first air brake chamber via a fifth fluid conduit;
a parking brake sub-system connected to the air reservoir arrangement and configured to be controlled by an electronic parking brake system, and to automatically apply at least one parking brake to at least one wheel of the vehicle when an air pressure provided by the air reservoir arrangement falls below a predefined parking brake threshold pressure; and
a braking system control unit coupled to first flow control device, the second flow control device, and the third flow control device;
the braking system control unit being configured to control, in response to a set of indications including an indication of malfunction of the electronic parking brake system:
an indication of a parking brake demand; and
an indication that the vehicle is stationary;
wherein the third flow control device prevents the pressure inside the first air brake chamber from going below the first service brake threshold pressure; and
wherein each of the first flow control device and the second flow control device allow air from the air reservoir arrangement to be discharged from the braking system, until the pressure provided by the air reservoir arrangement has fallen below the predefined parking brake threshold pressure.

2. The braking system of claim 1, wherein:
the first flow control device is controllable between a first state in which it allows flow of air from the air reservoir arrangement into the second fluid conduit, and a second state in which it allows air from the second fluid conduit to be discharged from the braking system;
the second flow control device is controllable between a first state in which it allows flow of air from the air reservoir arrangement into the fourth fluid conduit, and a second state in which it allows air from the fourth fluid conduit to be discharged from the braking system; and
the braking system control unit is configured to control:
the first flow control device to alternate between its first state and its second state; and
the second flow control device to alternate between its first state and its second state;
thereby allowing air from the air reservoir arrangement to be discharged from the braking system.

3. The braking system of claim 2, wherein the braking system control unit is configured to control the second flow control device to alternate between its first state and its second state with an increasing alternation frequency.

4. The braking system of claim 1, wherein the air reservoir arrangement comprises:
at least one first air tank connected to the first flow control device via the first fluid conduit; and
at least one second air tank connected to the second flow control device via the third fluid conduit.

5. The braking system of claim 4, further comprising:
at least one fourth flow control device connected to the first air tank, to the second air tank, and to the parking brake sub-system;
the fourth flow control device being configured to provide to the parking brake sub-system a highest air pressure of a first air pressure provided by the first air tank and a second air pressure provided by the second air tank.

6. The braking system of claim 4, further comprising:
at least one fifth flow control device arranged to control a flow of air between the first air tank and the second air tank;
the fifth flow control device being configured to prevent flow of air between the first air tank and the second air tank in response to at least one of a first air pressure provided by the first air tank and a second air pressure provided by the second air tank becoming lower than a predefined air tank pressure.

7. A vehicle comprising:
vehicle wheels; and
the braking system of claim 1 arranged to brake at least one of the vehicle wheels.

8. A method of operating a braking system for a heavy duty vehicle, the braking system comprising:
an air reservoir arrangement for storing pressurized air for operation of the braking system;
at least one first air brake chamber configured to engage a service brake of a first wheel of the vehicle when an air pressure inside the first air brake chamber is higher than a predefined first service brake threshold pressure;
at least one first flow control device connected to the air reservoir arrangement via a first fluid conduit and connected to the first air brake chamber via a second fluid conduit;
at least one second air brake chamber configured to engage a service brake of a second wheel of the vehicle when an air pressure inside the second air brake chamber is higher than a predefined second service brake threshold pressure;
at least one second flow control device connected to the air reservoir arrangement via a third fluid conduit and connected to the second air brake chamber via a fourth fluid conduit;
at least one third flow control device connected to the first flow control device via the second fluid conduit, and to the first air brake chamber via a fifth fluid conduit;
a parking brake sub-system connected to the air reservoir arrangement and configured to be controlled by an electronic parking brake system, and to automatically apply at least one parking brake to at least one wheel of the vehicle when an air pressure provided by the air reservoir arrangement falls below a predefined parking brake threshold pressure; and
a braking system control unit coupled to first flow control device, the second flow control device, and the third flow control device, the method comprising:
controlling, by the braking system control unit, in response to a set of indications including an indication of malfunction of the electronic parking brake system:
an indication of a parking brake demand; and
an indication that the vehicle is stationary;
wherein the third flow control device prevents the pressure inside the first air brake chamber from going below the first service brake threshold pressure; and
wherein each of the first flow control device and the second flow control device to allow air from the air reservoir arrangement to be discharged from the braking system, until the pressure provided by the air reservoir arrangement has fallen below the predefined parking brake threshold pressure.

9. A braking system for a heavy duty vehicle, comprising:
an air reservoir arrangement for storing pressurized air for operation of the braking system;
a first air brake chamber configured to engage a service brake of a first wheel of the vehicle when an air pressure inside the first air brake chamber is higher than a predefined first service brake threshold pressure;
a first flow control device connected to the air reservoir arrangement via a first fluid conduit and connected to the first air brake chamber via a second fluid conduit, the first flow control device being controllable between a first state in which it allows flow of air from the air reservoir arrangement into the second fluid conduit, and a second state in which it allows air from the second fluid conduit to be discharged from the braking system;
a second air brake chamber configured to engage a service brake of a second wheel of the vehicle when an air pressure inside the second air brake chamber is higher than a predefined second service brake threshold pressure;
a second flow control device connected to the air reservoir arrangement via a third fluid conduit and connected to the second air brake chamber via a fourth fluid conduit, the second flow control device being controllable between a first state in which it allows flow of air from the air reservoir arrangement into the fourth fluid conduit, and a second state in which it allows air from the fourth fluid conduit to be discharged from the braking system;
a parking brake sub-system connected to the air reservoir arrangement and configured to be controlled by an electronic parking brake system, and to automatically apply a parking brake to at least one wheel of the vehicle when an air pressure provided by the air reservoir arrangement falls below a predefined parking brake threshold pressure; and
a braking system control unit coupled to the first flow control device, and the second flow control device;
the braking system control unit being configured to control, in response to a set of indications including an indication of malfunction of the electronic parking brake system, an indication of a parking brake demand, and an indication that the vehicle is stationary:
the first flow control device to alternate between its first state and its second state, in such a way that the first flow control device is in its second state only when the second flow control device is in its first state; and
the second flow control device to alternate between its first state and its second state, in such a way that the second flow control device is in its second state only when the first flow control device is in its first state, until the pressure provided by the air reservoir arrangement has fallen below the predefined parking brake threshold pressure.

10. The braking system of claim 9, wherein the braking system control unit is configured to control at least one of the first flow control device and the second flow control device to alternate between its first state and its second state with an increasing alternation frequency.

11. The braking system of claim 9, wherein the air reservoir arrangement comprises:
at least one first air tank connected to the first flow control device via the first fluid conduit; and
at least one second air tank connected to the second flow control device via the third fluid conduit.

12. The braking system of claim 11, further comprising:
at least one fourth flow control device connected to the first air tank, to the second air tank, and to the parking brake sub-system;
the fourth flow control device being configured to provide to the parking brake sub-system a highest air pressure of a first air pressure provided by the first air tank and a second air pressure provided by the second air tank.

13. The braking system of claim 11, further comprising:
at least one fifth flow control device arranged to control a flow of air between the first air tank and the second air tank;
the fifth flow control device being configured to prevent flow of air between the first air tank and the second air tank in response to at least one of a first air pressure provided by the first air tank and a second air pressure provided by the second air tank becoming lower than a predefined air tank pressure.

14. A vehicle comprising:
vehicle wheels; and
the braking system of claim 9 arranged to brake at least one of the vehicle wheels.

15. A method of operating a braking system for a heavy duty vehicle, the braking system comprising:
an air reservoir arrangement for storing pressurized air for operation of the braking system; at least one first air brake chamber configured to engage a service brake of a first wheel of the vehicle when an air pressure inside the first air brake chamber is higher than a predefined first service brake threshold pressure;
at least one first flow control device connected to the air reservoir arrangement via a first fluid conduit and connected to the first air brake chamber via a second fluid conduit;
at least one second air brake chamber configured to engage a service brake of a second wheel of the vehicle when an air pressure inside the second air brake chamber is higher than a predefined second service brake threshold pressure;
at least one second flow control device connected to the air reservoir arrangement via a third fluid conduit and connected to the second air brake chamber via a fourth fluid conduit;
a parking brake sub-system connected to the air reservoir arrangement and configured to be controlled by an electronic parking brake system, and to automatically apply at least one parking brake to at least one wheel of the vehicle when an air pressure provided by the air reservoir arrangement falls below a predefined parking brake threshold pressure; and
a braking system control unit coupled to first flow control device and the second flow control device, the method comprising:
controlling, by the braking system control unit, in response to a set of indications including an indication of malfunction of the electronic parking brake system:
an indication of a parking brake demand; and
an indication that the vehicle is stationary;
wherein the first flow control device alternates between its first state and its second state, in such a way that the second flow control device is in its second state only when the first flow control device is in its first state; and
wherein the second flow control device alternates between its first state and its second state, in such a way that the second flow control device is in its second state only when the first flow control device is in its first state, until the pressure provided by the air reservoir arrangement has fallen below the predefined parking brake threshold pressure.
